(19) United States
(12) Patent Application Publication
(10) Pub. No.: US 2026/0253618 A1
(43) Pub. Date: Aug. 27, 2026

(54) LIQUID COOLING HEAT DISSIPATION DEVICE FOR MULTI-DISK DRIVE SYSTEM

(71) Applicant: Celestica Technology Consultancy (Shanghai) Co. Ltd, Shanghai (CN)

(72) Inventors: Xiaoliang Zhou, Shanghai (CN); Renyong Yu, Shanghai (CN); Yaoyin Fan, Shanghai (CN)

(21) Appl. No.: 19/331,935

(22) Filed: Sep. 17, 2025

(30) Foreign Application Priority Data
Feb. 26, 2025 (CN) 2025102217603

(51) Int. Cl. G11B 33/14

(52) U.S. Cl. CPC G11B 33/1413

(57) ABSTRACT

Provided is a liquid cooling heat dissipation device for a multi-disk drive system, comprising: a chassis having a plurality of disk drive mounting positions internally; one or more cold plates fixed inside the chassis, wherein a coolant flow channel is provided in the cold plate; a manifold cold plate assembly including an inlet manifold cold plate and an outlet manifold cold plate, respectively connected to two ends of the flow channel of the cold plate, and configured to guide a coolant to flow into and out of the cold plate; a plurality of disk drive cartridges, each is detachably mounted in the chassis and accommodates one or more disk drives. Compared to traditional air cooling solutions, the device of the present disclosure can better cope with high thermal loads, ensuring that disk drives maintain good performance and stability under high-load operation conditions.

### FIELD OF TECHNOLOGY

The present disclosure relates to the field of heat dissipation technology for disk drives, and in particular, to a liquid cooling heat dissipation device for a multi-disk drive system.

### BACKGROUND

With the rapid development of information technology (IT), the demand for data storage has experienced explosive growth. Multi-disk drive systems, such as high-density disk drive (HDD) storage devices and servers, have been widely adopted in data centers and enterprise-level storage applications due to their advantages of large capacity and high reliability. However, these systems face increasingly severe heat dissipation challenges during operation.

Conventional air cooling solutions primarily rely on fans to force airflow for dissipating heat generated by disk drives. However, with continuous advancements in HDD technology featuring increased storage capacities and reduced head-to-track spacing, HDDs exhibit significantly enhanced sensitivity to external acoustic and vibrational disturbances. Higher component integration densities in the systems have substantially diminished the clearance between fans and HDD assemblies, consequently amplifying the influence of fan-induced vibrations and noise on the disk drives, thereby necessitating elevated fan rotational speeds to cope with higher thermal load. This not only increases power consumption but also exacerbates vibrational and acoustic emissions, ultimately degrading the disk drives'performance.

Therefore, the traditional air cooling solutions have many shortcomings in meeting the heat dissipation requirements of multi-disk drive systems and struggle to satisfy the performance demands of future mechanical disk drives with even higher capacities.

### SUMMARY

The present disclosure provides a liquid cooling heat dissipation device for a multi-disk drive system, which is capable of significantly improving the heat dissipation efficiency of the multi-disk drive system.

The present disclosure provides a liquid cooling heat dissipation device for a multi-disk drive system, comprising: a chassis having a plurality of disk drive mounting positions internally; one or more cold plates fixed inside the chassis, wherein a coolant flow channel is provided in the cold plate; a manifold cold plate assembly, including an inlet manifold cold plate and an outlet manifold cold plate, respectively connected to two ends of the flow channel of the cold plate, and configured to guide a coolant to flow into and out of the cold plate; a plurality of disk drive cartridges, wherein each disk drive cartridge is detachably mounted in the chassis and accommodates one or more disk drives.

In some embodiments, a path of the coolant flow channel is configured to form a parallel flow channel or an S-shaped flow channel, and the inlet manifold cold plate and the outlet manifold cold plate are both arranged perpendicular to an extension direction of the cold plate.

In some embodiments, a plurality of parallel partition plates are provided inside the cold plate. When the path of the coolant flow channel is the parallel flow channel, each partition plate is provided with a plurality of openings extending along the same direction. When the path of the coolant flow channel is the S-shaped flow channel, each partition plate is provided with an opening, and the opening on each partition plate is staggered relative to the openings of the adjacent partition plates.

In some embodiments, a plurality of cold plates are provided inside the chassis, and the cold plates are arranged horizontally or vertically to divide the chassis into a plurality of independent heat dissipation regions. The size of each heat dissipation region is adapted to the mounting mode of the disk drive cartridge. The disk drive cartridge is mounted by being inserted or extracted in a front-back direction parallel to a surface of the horizontally oriented cold plate, or an up-down direction parallel to a surface of the vertically oriented cold plate.

In some embodiments, the disk drive cartridge is adapted to disk drives of various specifications, including 3.5-inch HDD, 2.5-inch HDD, 2.5-inch SSD, E1, and E3 specification disk drives. The compatible heat dissipation is achieved by adjusting the spacing of the cold plates and the size of the disk drive cartridge.

In some embodiments, the liquid cooling heat dissipation device further includes a first thermal interface disposed between the disk drive and an inner surface of the disk drive cartridge, and a second thermal interface disposed between an outer surface of the disk drive cartridge and the cold plate. The disk drive cartridge sequentially transfers heat from the disk drive to the cold plate via the first and second thermal interfaces, and the manifold cold plate assembly dissipates the heat using a coolant circulation device.

In some embodiments, the first thermal interface and/or the second thermal interface include one or more of silicone grease, graphene sheets, phase change material, and metal spring sheets. The metal spring sheets are in elastic contact with the disk drive cartridge or the cold plate to compensate for assembly tolerances.

In some embodiments, the coolant circulation device includes a temperature sensor and a flow regulating valve. The temperature sensor is provided at the outlet manifold cold plate of the cold plate to monitor a coolant temperature in real time. The flow regulating valve is configured to dynamically adjust a coolant flow rate according to temperature feedback, to achieve a match between heat dissipation power and a disk drive thermal load.

In some embodiments, the disk drive cartridge is provided with an independent power interface. The power interface is connected to a redundant power bus in the chassis and supports hot-swap operation. An electrical isolation module is provided in the chassis for cutting off a local circuit when the disk drive cartridge is inserted or extracted, to maintain power supply continuity for other disk drive cartridges.

In some embodiments, the disk drive cartridge is a fully enclosed structure, covering an upper surface, a lower surface, and side walls of the disk drive. The outer surface of the disk drive cartridge and the cold plate perform heat conduction through surface contact or line contact.

The liquid cooling heat dissipation device for the multi-disk drive system of the present disclosure has at least the following advantages.
(1) The disk drive liquid cooling device of the present disclosure effectively addresses the thermal dissipation challenges of high-density disk drive systems. Compared to traditional air cooling solutions, it can better cope with high thermal loads, ensuring that the disk drives maintain good performance and stability even under high-load operation conditions.
(2) By replacing the fans used in traditional air-cooling, the liquid cooling device mitigates the vibration and noise generated by fan operation. This reduces the detrimental effects of these factors on mechanical disk drive performance, thereby enhancing the accuracy and reliability of data read/write operations.
(3) The present disclosure provides an effective heat dissipation solution for current and future higher-capacity mechanical disk drives. It addresses the demands of data centers and enterprise-level storage for large-capacity storage devices and facilitates the advancement of disk drive technology.
(4) Disk drives can be inserted and extracted from the front without requiring the entire device to be detached from the chassis. This significantly simplifies the maintenance process, reducing its complexity and workload, and improving maintenance efficiency.
(5) During the maintenance process, the entire device remains powered on, enabling continuous, uninterrupted operation. This ensures high system availability and business continuity, minimizing downtime caused by maintenance activities.
(6) The design of the cartridge, which fully encloses the disk drive, prevents surface wear during maintenance, insertion, and extraction. This extends the disk drive's service life and lowers the device's maintenance costs.

### BRIEF DESCRIPTION OF THE DRAWINGS

FIG. 1 is a schematic structural diagram of a liquid cooling heat dissipation device for a multi-disk drive system according to one embodiment of the present disclosure.

FIG. 2 is a schematic structural diagram of a liquid cooling heat dissipation device for a multi-disk drive system according to another embodiment of the present disclosure.

FIG. 3 is a schematic structural diagram of a parallel flow channel according to one embodiment of the present disclosure.

FIG. 4 is a schematic structural diagram of an S-shaped flow channel according to one embodiment of the present disclosure.

FIG. 5 is a schematic structural diagram of a disk drive cartridge for accommodating a plurality of disk drives according to one embodiment of the present disclosure.

FIG. 6 is a schematic structural diagram of a disk drive cartridge for accommodating a single disk drive according to one embodiment of the present disclosure.

FIG. 7 is a front view of a disk drive cartridge according to one embodiment of the present disclosure.

FIG. 8 is a front view of an exemplary liquid cooling heat dissipation device of the present disclosure.

FIG. 9 is a schematic diagram of a first thermal interface between a disk drive cartridge and a disk drive according to one embodiment of the present disclosure.

FIG. 10 is a schematic diagram of a second thermal interface between a disk drive cartridge and a cold plate according to one embodiment of the present cartridge.

Reference Numerals
11 Chassis
12 Cold Plate
13 Manifold Cold Plate Assembly
131 Inlet Manifold Cold Plate
132 Outlet Manifold Cold Plate
14 Disk Drive Cartridge
15 Disk Drive
16 Partition Plate
17 First Thermal Interface
18 Second Thermal Interface

### DETAILED DESCRIPTION

The following describes the embodiments of the present disclosure through specific examples. Those skilled in the art can easily understand the other advantages and effects of the present disclosure from the content disclosed in this specification. The present disclosure can also be implemented or applied through other specific embodiments. The details in this specification can also be modified or changed based on different viewpoints and applications without departing from the present disclosure. It should be noted that the following embodiments and features in the embodiments can be combined with each other in the absence of any conflict.

It should be noted that the illustrations provided in the following embodiments are merely schematic illustrations of the basic concept of the present disclosure. Therefore, the illustrations only show components related to the present disclosure and are not drawn according to the number, shape, and size of components in actual implementation. In actual implementation, the shape, quantity, and proportion of each component may be changed arbitrarily, and the component layout may also be more complex.

As core components of data centers and enterprise-level storage systems, the capacity of hard disk drives (HDDs) continues to increase to meet escalating data storage demands. However, such capacity expansion imposes stricter requirements on head positioning accuracy, where even minor vibrations may cause head off-track events, adversely affecting data read/write speed and accuracy. Increased component density restricts airflow between cooling fans and disk drives, reducing heat dissipation efficiency. Furthermore, the vibrations and acoustic noise generated by fan operation are more easily transmitted to the disk drives, interfering with their normal operation. Moreover, elevated fan speeds not only increase power consumption but may also generate greater vibrations and noise, collectively exacerbating the operation environment of the disk drives.

The present disclosure provides a liquid cooling heat dissipation device for a multi-disk drive system. The technical solution in the embodiments of the present disclosure will be described in detail below with reference to the drawings of the present disclosure.

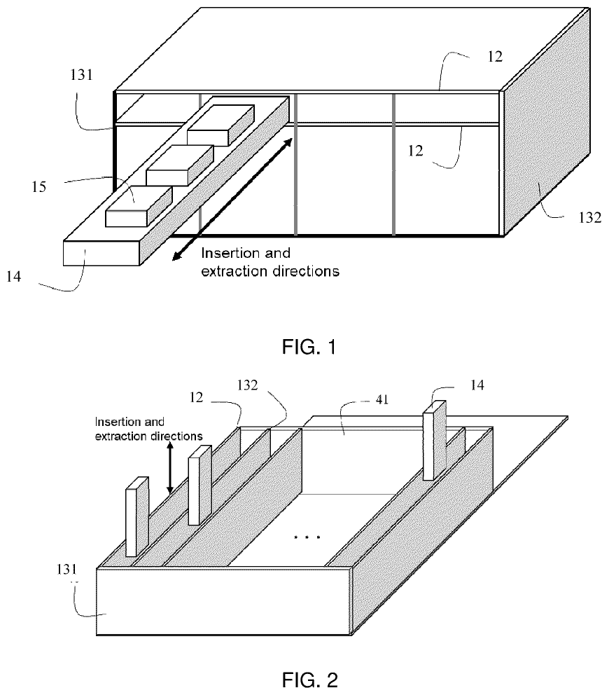

As shown in FIG. 1 and FIG. 2, the present disclosure provides a liquid cooling heat dissipation device for a multi-disk drive system, comprising: a chassis 11, one or more cold plates 12, a manifold cold plate assembly 13, and a plurality of disk drive cartridges 14.

The chassis 11 has a plurality of disk drive mounting positions internally.

Specifically, the size and shape of the chassis 11 are designed according to specific application requirements to accommodate different quantities and sizes of disk drive cartridges 14. The chassis 11 typically adopts a standard 19-inch rack design, which is convenient for installation and deployment in a data center or server room. The chassis 11 is made of high-strength metal materials, such as cold-rolled steel plate or aluminum alloy, to ensure its structural strength and durability. A surface of the chassis 11 undergoes spray coating or anodization treatment, providing excellent corrosion resistance and appearance quality. The chassis 11 incorporates heat dissipation channels and ventilation holes internally, to ensure the flow of a coolant in the cold plate 12 and the dissipation of heat. The heat dissipation design of the chassis 11 considers airflow and heat distribution, thereby optimizing the heat dissipation effect.

The cold plate 12 is fixed inside the chassis 11, and a coolant flow channel is provided inside the cold plate 12.

Specifically, the cold plate 12 is made of a material with high thermal conductivity, such as copper or aluminum, to ensure efficient heat conduction. A surface of the cold plate 12 undergoes special treatment, such as anodization or coating, to improve its corrosion resistance and thermal conductivity. The cold plate 12 is secured to the interior of the chassis 11 with bolts, snap-fit connectors, or other fastening devices, to ensure its stable position and prevent displacement due to vibration or other external forces.

The cold plate 12 has a coolant flow channel internally, configured to guide a coolant to flow within the cold plate 12, and remove the heat generated by a disk drive 15. In some embodiments, the coolant flow channel may be designed as a parallel flow channel or an S-shaped flow channel, depending on the heat dissipation demand and system design. The parallel flow channel includes a plurality of parallel straight flow channels, allowing the coolant to flow uniformly within the cold plate 12. The S-shaped flow channel includes a plurality of continuous S-shaped curved channels, which increase the flow path length of the coolant and improve heat exchange efficiency.

In some embodiments, a plurality of parallel partition plates 16 are provided inside the cold plate 12. When the path of the coolant flow channel is the parallel flow channel, each partition plate 16 is provided with a plurality of openings extending along the same direction. When the path of the coolant flow channel is the S-shaped flow channel, each partition plate 16 is provided with an opening, and the opening on each partition plate 16 is staggered relative to the openings of the adjacent partition plates 16.

Specifically, the partition plates 16 inside the cold plate 12 are arranged in parallel, with a certain distance between each partition plate 16 to form the coolant flow channel, which ensures that the flow path of the coolant in the cold plate 12 is uniform and controllable.

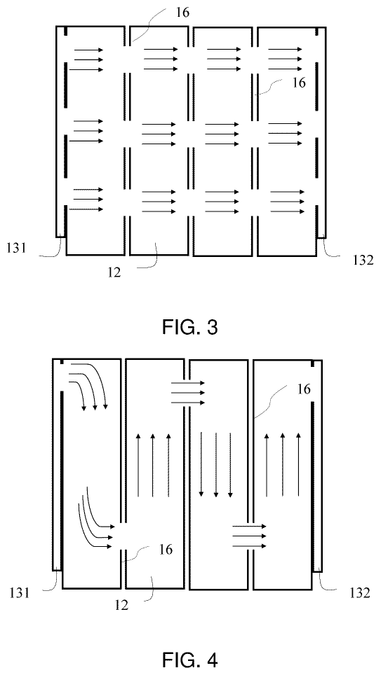

As shown in FIG. 3, when the path of the coolant flow channel is the parallel flow channel, each partition plate 16 is provided with a plurality of openings extending along the same direction. These openings form the parallel coolant flow channels between the adjacent partition plates 16, ensuring that the coolant flows along the parallel paths within the cold plate 12. The design of the parallel flow channel allows the coolant to flow uniformly across all regions of the cold plate 12, thereby improving heat dissipation efficiency.

As shown in FIG. 4, when the path of the coolant flow channel is the S-shaped flow channel, each partition plate 16 is provided with an opening, and the opening on each partition plate 16 is staggered relative to the openings on the adjacent partition plates 16. This staggered arrangement creates an S-shaped flow path for the coolant within the cold plate 12, increasing the length of the flow path for the coolant. The design of the S-shaped flow channel improves heat exchange efficiency, ensuring effective heat dissipation of all regions of the cold plate 12.

Furthermore, to enhance the heat exchange efficiency of the coolant, each partition plate 16 is provided with turbulator structures in the form of raised fins or recessed grooves. Fins are typically raised, thin, sheet-like structures that can be arranged vertically or obliquely on an inner wall of the partition plate 16. Grooves are recessed, trough-like structures that can be arranged along or perpendicular to the direction of the flow channel.

The turbulator structures may be arranged evenly or unevenly on the partition plate 16. Evenly arranged turbulator structures ensure consistent heat exchange throughout the entire flow channel, while unevenly arranged turbulator structures can be optimized based on a thermal load distribution within the flow channel to improve heat exchange efficiency in specific regions. The turbulator structures can be arranged parallel or perpendicular to the flow direction of the coolant. The turbulator structures aligned with the flow direction can reduce the flow resistance of the coolant, while the turbulator structures perpendicular to the flow direction can increase the contact area between the coolant and the inner wall of the flow channel, improving heat exchange efficiency.

The manifold cold plate assembly 13 includes an inlet manifold cold plate 131 and an outlet manifold cold plate 132, respectively connected to two ends of the flow channel of the cold plate 12, to guide the coolant to flow into and out of the cold plate.

Specifically, the inlet manifold cold plate 131 and the outlet manifold cold plate 132 are arranged perpendicular to an extension direction of the cold plate 12, ensuring that the coolant is evenly distributed to each flow channel and uniformly collected upon exit. The coolant enters through the inlet manifold cold plate 131 and flows through the cold plate 12 via the flow channels, and is finally collected at the outlet manifold cold plate 132 for outflow, removing heat through the coolant circulation device.

A plurality of disk drive cartridges 14 are provided. Each disk drive cartridge 14 is detachably disposed in the chassis 11 and accommodates one or more disk drives 15.

In some embodiments, the disk drive cartridge 14 is a fully enclosed structure, covering an upper surface, a lower surface, and side walls of the disk drive 15. The outer surface of the disk drive cartridge 14 and the cold plate 12 perform heat conduction through surface contact or line contact.

Specifically, as shown in FIGS. 5-7, the disk drive cartridge 14 utilizes a fully enclosed structure, covering the upper surface, the lower surface, and the side walls of the disk drive 15, ensuring comprehensive protection of the disk drive 15 during operation and maintenance. This fully enclosed design effectively prevents physical damage to the disk drive 15 during insertion and extraction, while minimizing the impact of dust and foreign matter on the disk drive 15. The housing of the disk drive cartridge 14 is made of a material with excellent thermal conductivity, such as aluminum alloy or magnesium alloy, to ensure efficient heat conduction.

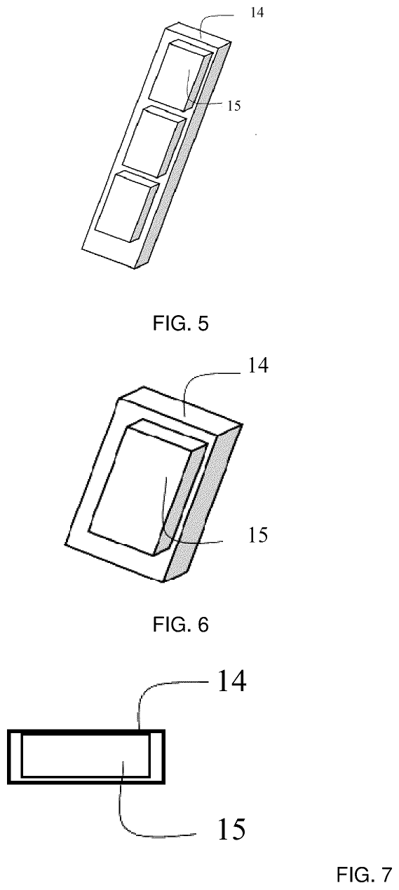

FIG. 5 is a schematic structural diagram of a disk drive cartridge for accommodating a plurality of disk drives according to one embodiment of the present disclosure. A plurality of disk drives are integrated into a single disk drive cartridge 14, suitable for the demand of high-density storage. FIG. 6 is a schematic structural diagram of a disk drive cartridge for accommodating a single disk drive according to one embodiment of the present disclosure. Each disk drive cartridge 14 accommodates only one disk drive 15, facilitating flexible management and maintenance.

In some embodiments, a plurality of cold plates 12 are provided in the chassis 11, and the cold plates 12 are arranged in a horizontal or vertical direction to divide the chassis 11 into a plurality of independent heat dissipation regions, and a size of each heat dissipation region is adapted to a mounting mode of the disk drive cartridge 14. The disk drive cartridge 14 is mounted by being inserted or extracted in a front-back direction parallel to a surface of the horizontally oriented cold plate 12 or an up-down direction parallel to a surface of the vertically oriented cold plate 12.

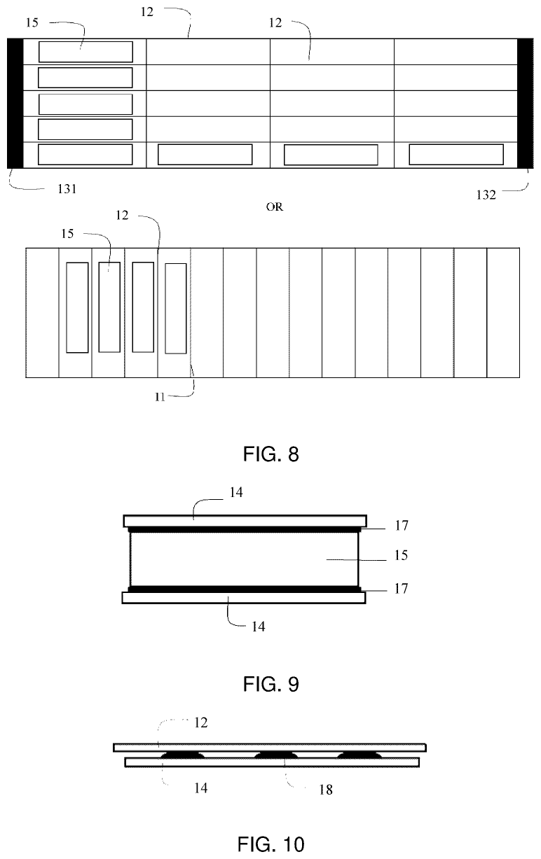

For example, taking chassis 11 with a width of 19 inches and a height of 4 RU as an example, the mounting of the cold plate 12 is shown in FIG. 8. From the front view, the cold plate 12 divides the system into 20 regions, each of which can accommodate a disk drive cartridge 14.

For example, FIG. 1 illustrates a mounting mode of a disk drive cartridge being inserted and extracted in a horizontal direction in a front-back manner. FIG. 2 illustrates a mounting mode of a disk drive cartridge being inserted and extracted in a vertical direction in an up-down manner.

In this embodiment, the cold plate layout and the mounting mode of the disk drive cartridge within the chassis not only improve heat dissipation efficiency, but also ensure easy mounting and maintenance of the disk drive cartridges. Horizontal or vertical cold plate arrangement can be optimized based on specific application demand, while insertion and extraction in the front-back or up-down manner provide greater flexibility for maintenance personnel.

In some embodiments, the disk drive cartridge 14 is provided with an independent power interface. The power interface is connected to a redundant power bus in the chassis 11, and supports hot-swap operation of the disk drive cartridge 14. An electrical isolation module is provided in the chassis 11 and configured to cut off a local circuit when the disk drive cartridge 14 is inserted or extracted, to maintain power supply continuity for other disk drive cartridges 14.

Specifically, the disk drive cartridge 14 is provided with an independent power interface that is configured to connect to the redundant power bus within the chassis 11, ensuring that the disk drive cartridge 14 can be independently powered. The power interface automatically connects and supplies power when the disk drive cartridge 14 is inserted into the chassis 11, ensuring that the disk drive cartridge 14 can start operating immediately. When the disk drive cartridge 14 is extracted, the power interface automatically disconnects, ensuring safe operation and preventing device damage or data loss caused by hot insertion and extraction.

The chassis 11 is provided with a redundant power bus that connects the independent power interfaces of the plurality of disk drive cartridges 14, ensuring a stable power supply to each disk drive cartridge 14. The redundant power bus utilizes dual power modules or a power system with a backup battery, ensuring that if a main power module fails, a backup power module can immediately take over the power supply, thereby ensuring continuous operation of the system.

In addition, the chassis 11 is further provided with an electrical isolation module, which is configured to cut off the local circuit when the disk drive cartridge 14 is inserted or extracted. This ensures that the insertion or extraction of one disk drive cartridge 14 does not affect the power supply of other disk drive cartridges 14. The electrical isolation module uses an optical coupler, relay, or other isolation device to achieve circuit isolation and switching, ensuring that when the disk drive cartridge 14 is inserted or extracted, the local circuit can be quickly disconnected while other circuits maintain a normal power supply.

In this embodiment, the independent power interface of the disk drive cartridge, the redundant power bus, and the electrical isolation module collectively ensure the hot-swap operation safety of the disk drive cartridge and the continuous operation of the system, thereby improving the reliability and maintenance efficiency of the multi-disk drive system.

In some embodiments, the disk drive cartridge 14 is adapted to disk drives of various specifications, including 3.5-inch HDD, 2.5-inch HDD, 2.5-inch SSD, E1, and E3 specification disk drives. The compatible heat dissipation can be achieved by adjusting the spacing of the cold plate 12 and the size of the disk drive cartridge 14.

In some embodiments, a first thermal interface 17 and a second thermal interface 18 are provided. As shown in FIG. 9, the first thermal interface 17 is disposed between the disk drive 15 and an inner surface of the disk drive cartridge 14. As shown in FIG. 10, the second thermal interface 18 is disposed between an outer surface of the disk drive cartridge 14 and the cold plate 12. The disk drive cartridge 14 sequentially transfers heat from the disk drive 15 to the cold plate 12 via the first thermal interface 17 and the second thermal interface 18, and the manifold cold plate assembly 13 dissipates the heat using a coolant circulation device.

For example, the first thermal interface 17 and/or the second thermal interface 18 includes one or more of: silicone grease, graphene sheets, phase change material, and metal spring sheets. The metal spring sheets are in elastic contact with the disk drive cartridge 14 or the cold plate 12 to compensate for assembly tolerances.

Specifically, the silicone grease has good thermal conductivity and filling properties, and can effectively fill a tiny gap between the disk drive 15 and the inner surface of the disk drive cartridge 14, ensuring efficient heat transfer. The graphene sheet has an extremely high thermal conductivity coefficient and can quickly transfer the heat from the disk drive 15 to the disk drive cartridge 14. The phase change material undergoes a phase change within a specific temperature range and can absorb and release large amounts of heat, thereby regulating the temperature. The metal spring sheet can compensate for the assembly tolerance between the disk drive cartridge 14 and the cold plate 12 through elastic contact, ensuring close contact of the thermal interfaces and improving thermal efficiency.

To achieve efficient heat dissipation control and system optimization, in some embodiments, the coolant circulation device includes a temperature sensor and a flow regulating valve. The temperature sensor is disposed at the outlet manifold cold plate 132 of the cold plate 12 to monitor a coolant temperature in real time. The flow regulating valve dynamically adjusts the coolant flow rate according to temperature feedback, to achieve a match between the heat dissipation power and the thermal load of the disk drive 15.

Specifically, the temperature sensor typically uses a negative temperature coefficient (NTC) thermistor whose resistance decreases as temperature increases, converting a temperature change into an electrical signal. In this way, the temperature sensor can accurately measure the coolant temperature and feed the data back to a control system.

The flow regulating valve can automatically adjust the flow of the coolant according to real-time temperature data, to achieve a precise match between the heat dissipation power and the disk drive thermal load.

The coolant circulation system achieves efficient heat dissipation control through the coordinated operation of the temperature sensor and the flow regulating valve. The temperature sensor monitors the coolant temperature change in real time and feeds the data back to the control system. The control system dynamically adjusts the opening degree of the flow regulating valve based on the data, thereby varying the coolant flow rate. This closed-loop control mechanism ensures that the heat dissipation system is optimally adjusted based on the actual thermal load of the disk drive, thereby preventing overcooling or overheating while improving overall system efficiency.

The above embodiments are merely illustrative of the principles and effects of the present disclosure and are not intended to limit the present disclosure. Those skilled in the art may modify or alter the above embodiments without departing from the scope of the present disclosure. Therefore, all equivalent modifications or alterations made by those having ordinary skills in the art without departing from the technical concepts disclosed in the present disclosure shall be covered by the claims of the present disclosure.

1.-10. (canceled)

11. A liquid cooling heat dissipation device, the device comprising:
a chassis having a plurality of disk drive mounting positions internally;
a cold plate fixed inside the chassis, wherein a coolant flow channel is provided in the cold plate;
a manifold cold plate assembly including an inlet manifold cold plate and an outlet manifold cold plate, respectively connected to two ends of the coolant flow
channel of the cold plate, and configured to guide a coolant to flow into and out of the cold plate;
a disk drive cartridge detachably mounted in the chassis and configured accommodate one or more disk drives.

12. The device of claim 11, wherein a path of the coolant flow channel is configured to form a parallel flow channel, and the inlet manifold cold plate and the outlet manifold cold plate are both arranged perpendicular to an extension direction of the cold plate.

13. The device of claim 12, wherein a plurality of parallel partition plates are provided inside the cold plate, and
wherein each partition plate is provided with a plurality of openings extending along a same direction.

14. The device of claim 11, wherein a path of the coolant flow channel is configured to form an S-shaped flow channel, and the inlet manifold cold plate and the outlet manifold cold plate are both arranged perpendicular to an extension direction of the cold plate.

15. The device of claim 14, wherein a plurality of parallel partition plates are provided inside the cold plate, and
wherein each partition plate is provided with an opening, and the opening on each partition plate is staggered relative to the openings of adjacent partition plates.

16. The device of claim 11, wherein a plurality of cold plates are provided inside the chassis.

17. The device of claim 11, wherein a plurality of cold plates are provided inside the chassis,
wherein the cold plates are arranged horizontally to divide the chassis into a plurality of independent heat dissipation regions,
wherein a size of each heat dissipation region is adapted to a mounting mode of the disk drive cartridge, and
wherein the disk drive cartridge is mounted by being inserted or extracted in a front-back direction parallel to a surface of the cold plates.

18. The device of claim 11, wherein a plurality of cold plates are provided inside the chassis,
wherein the cold plates are arranged vertically to divide the chassis into a plurality of independent heat dissipation regions,
wherein a size of each heat dissipation region is adapted to a mounting mode of the disk drive cartridge, and
wherein and the disk drive cartridge is mounted by being inserted or extracted in an up-down direction parallel to a surface of the cold plates.

19. The device of claim 11, wherein the disk drive cartridge is adapted to disk drives of various specifications, comprising 3.5-inch HDD, 2.5-inch HDD, 2.5-inch SSD, E1, or E3 specification disk drives, and compatible heat dissipation is achieved by adjusting a cold plate spacing and a size of the disk drive cartridge.

20. The device of claim 11, further comprising:
a first thermal interface disposed between the disk drive and an inner surface of the disk drive cartridge;
a second thermal interface disposed between an outer surface of the disk drive cartridge and the cold plate;
wherein the disk drive cartridge sequentially transfers heat from the disk drive to the cold plate via the first thermal interface and the second thermal interface, and the manifold cold plate assembly dissipates the heat using a coolant circulation device.

21. The device of claim 20, wherein at least one of the first thermal interface or the second thermal interface comprises one or more of: silicone grease, graphene sheets, phase change material, or metal spring sheets.

22. The device of claim 21, wherein the first thermal interface or the second thermal interface comprises metal spring sheets, and
wherein the metal spring sheets are in elastic contact with the disk drive cartridge or the cold plate to compensate for assembly tolerances.

23. The device of claim 20, wherein the coolant circulation device comprises a temperature sensor and a flow regulating valve.

24. The device of claim 23, wherein the temperature sensor is provided at the outlet manifold cold plate of the cold plate to monitor a coolant temperature in real time.

25. The device of claim 24, wherein the flow regulating valve is configured to dynamically adjust a coolant flow rate according to temperature feedback, to achieve a match between heat dissipation power and a disk drive thermal load.

26. The device of claim 11, wherein the disk drive cartridge is provided with an independent power interface,
wherein the power interface is connected to a redundant power bus in the chassis, and
wherein supports hot-swap operation of the disk drive cartridge.

27. The device of claim 26, wherein an electrical isolation module is provided in the chassis, configured to cut off a local circuit when the disk drive cartridge is inserted or extracted, to maintain power supply continuity for other disk drive cartridges.

28. The device of claim 11, wherein the disk drive cartridge is a fully enclosed structure, covering an upper surface, a lower surface, and side walls of the disk drive, and an outer surface of the disk drive cartridge and the cold plate perform heat conduction through surface contact or line contact.

29. The device of claim 11, further comprising:
a thermal interface disposed between the disk drive and an inner surface of the disk drive cartridge.

30. The device of claim 11, further comprising:
a thermal interface disposed between an outer surface of the disk drive cartridge and the cold plate.
